(19) United States
(12) Patent Application Publication
(10) Pub. No.: US 2019/0047417 A1
(43) Pub. Date: Feb. 14, 2019

(54) DRIVER STATE RECOGNITION APPARATUS, DRIVER STATE RECOGNITION SYSTEM, AND DRIVER STATE RECOGNITION METHOD

(71) Applicant: OMRON Corporation, Kyoto-shi (JP)

(72) Inventors: Hatsumi AOI, Kyotanabe-shi (JP); Tomoyoshi AIZAWA, Kyoto-shi (JP); Tadashi HYUGA, Hirakata-shi (JP); Kazuyoshi OKAJI, Omihachiman-shi (JP); Koji TAKIZAWA, Kyoto-shi (JP); Hiroshi SUGAHARA, Kyoto-shi (JP)

(73) Assignee: OMRON Corporation, Kyoto-shi (JP)

(21) Appl. No.: 16/037,064

(22) Filed: Jul. 17, 2018

(30) Foreign Application Priority Data
Aug. 10, 2017 (JP) 2017-155261

(51) Int. Cl. B60K 28/06; B60W 40/08; B60W 40/04; B60W 30/16; B60W 10/184; B60R 11/04

(52) U.S. Cl. CPC B60K 28/06; B60W 40/08; B60R 11/04; B60W 30/16; B60W 10/184; B60W 40/04

(57) ABSTRACT

A driver state recognition apparatus that recognizes a state of the driver of a vehicle provided with an autonomous driving system includes a load data acquisition unit that acquires load data measured by a load measurement unit provided at a foot of a driver's seat of the vehicle, a sitting posture inference unit that infers the driver's sitting posture using the load data acquired by the load data acquisition unit, and a readiness determination unit that determines whether the driver is able to immediately operate the pedal of the vehicle during autonomous driving, based on inference information from the sitting posture inference unit.

### CROSS-REFERENCES TO RELATED APPLICATIONS

This application claims priority to Japanese Patent Application No. 2017-155261 filed Aug. 10, 2017, the entire contents of which are incorporated herein by reference.

### FIELD

The disclosure relates to a driver state recognition apparatus, a driver state recognition system, and a driver state recognition method, and more particularly to a driver state recognition apparatus, a driver state recognition system, and a driver state recognition method that recognize a state of a driver of a vehicle that can drive autonomously.

### BACKGROUND

In recent years, development of autonomous driving technologies for vehicles has been actively pursued. It is required for a driver of a vehicle in which an autonomous driving system is installed to monitor the autonomous driving system even during autonomous driving, so that if, for example, an abnormality or failure occurs in the autonomous driving system, the autonomous driving system reaches the operating limit, or the autonomous driving control ends, the driver can smoothly take over a driving operation.

For example, in the following JP 4333797, a technology is disclosed for detecting drowsiness information such as the line of sight of the driver and the degree of opening of the eyelids from an image of the driver captured by a camera installed in the vehicle, calculating an actual degree of concentration using the drowsiness information, and reducing the traveling speed controlled by auto-cruise control in a case where the actual degree of concentration is lower than a required degree of concentration such as, for example, in a case where the driver's concentration decreases due to drowsiness.

As described above, if the driver dozes due to drowsiness during autonomous driving, the driver cannot monitor the autonomous driving system responsibly. As states in which the driver cannot monitor the autonomous driving system responsibly, various states other than the above dozing state are conceivable. In particular, during autonomous driving, the driver can adopt a posture that is not possible during manual driving, and thus the importance of recognizing the state of the driver during autonomous driving further increases. For example, it is necessary to appropriately recognize whether the driver is adopting a posture that enables the driver to immediately cope with manual driving even if the driving mode is switched from the autonomous driving mode to the manual driving mode because of the occurrence of a failure in the system during autonomous driving. However, in the monitoring method using the driver's drowsiness information disclosed in JP 4333797, there is a problem in that the posture of the driver cannot be appropriately recognized.

JP 4333797 is an example of background art.

### SUMMARY

One or more aspects have been made in view of the above circumstances, and one or more aspects may provide a driver state recognition apparatus, a driver state recognition system, and a driver state recognition method that can accurately recognize a driver's posture so as to enable the driver to promptly take over a driving operation, particularly operation of a pedal, even during autonomous driving.

In order to achieve the above object, a driver state recognition apparatus according to one or more aspects is a driver state recognition apparatus for recognizing a state of a driver of a vehicle provided with an autonomous driving system, including:

a load data acquisition unit configured to acquire load data that is measured by a load measurement unit provided at a foot of a driver's seat of the vehicle;

a sitting posture inference unit configured to infer a sitting posture of the driver using the load data acquired by the load data acquisition unit; and

a readiness determination unit configured to determine whether the driver is in a state of being able to immediately operate a pedal of the vehicle during autonomous driving, based on inference information from the sitting posture inference unit.

According to the above driver state recognition apparatus, the sitting posture of the driver is inferred using the load data measured by the load measurement unit, and it is determined, based on the inference information of the sitting posture, whether the driver can immediately operate the pedal of the vehicle during autonomous driving. In this configuration, it is possible to accurately recognize whether the driver is adopting a posture that enables the driver to promptly take over the pedal operation even during autonomous driving, and it is possible to provide support such that takeover of manual driving from autonomous driving, particularly takeover of the pedal operation, can be performed promptly and smoothly, even in cases such as where a failure occurs in the autonomous driving system during autonomous driving. Note that the pedal of the vehicle includes at least one of an accelerator pedal and a brake pedal.

Also, in the driver state recognition apparatus according to one or more aspects, if it is inferred by the sitting posture inference unit that the driver is adopting a sitting posture in which at least one foot is placed on a floor near the pedal of the vehicle, the readiness determination unit may determine that readiness is in a high state.

According to the above driver state recognition apparatus, it is possible to determine whether the driver is in the state of being able to immediately operate the pedal of the vehicle, based on a state in which one of the legs of the driver is placed near the pedal of the vehicle, and thus it is possible to determine this state by distinguishing from a state in which the foot of the driver is placed on the pedal.

The driver state recognition apparatus according to one or more aspects may further include a definition data storage unit configured to store definition data in which a pattern of load data measured by the load measurement unit and a pattern of a sitting posture of the driver are associated with each other, and

The sitting posture inference unit may infer the sitting posture of the driver, based on the load data acquired by the load data acquisition unit and the definition data read out from the definition data storage unit.

According to the above driver state recognition apparatus, the sitting posture of the driver is inferred, based on the load data acquired by the load data acquisition unit and the definition data read out from the definition data storage unit. For example, by collating the load data acquired by the load data acquisition unit with the definition data and extracting a sitting posture of the driver corresponding to the acquired load data from the definition data, it is possible to accurately infer a sitting posture of the driver.

Also, the driver state recognition apparatus according to one or more aspects may further include:

a foot detection data acquisition unit configured to acquire foot detection data of a pedal sensor configured to detect a state in which the foot of the driver is placed on the pedal of the vehicle, and

if the foot detection data acquisition unit acquires the foot detection data, the readiness determination unit may determine that the driver is in the state of being able to immediately operate the pedal of the vehicle during autonomous driving.

According to the above driver state recognition apparatus, if the foot detection data acquisition unit acquires the foot detection data, it is possible to determine that the driver is in a state of being able to immediately operate the pedal of the vehicle during autonomous driving regardless of an inference result from the sitting posture inference unit.

The driver state recognition apparatus according to one or more aspects may include a notification processing unit configured to perform predetermined notification processing based on a determination result of the readiness determination unit.

According to the above driver state recognition apparatus, by performing the predetermined notification processing based on the determination result of the readiness determination unit, it is possible to perform support in which the determination result is reflected with respect to the autonomous driving system.

Also, in the driver state recognition apparatus according to one or more aspects, if it is determined by the readiness determination unit that the driver is not in the state of being able to immediately operate the pedal of the vehicle, the notification processing unit may perform notification processing for prompting the driver to adopt an appropriate foot posture.

According to the above driver state recognition apparatus, if it is determined that the driver is not in a state of being able to immediately operate the pedal of the vehicle, notification processing for prompting the driver to adopt an appropriate foot posture is performed. In this manner, it is possible to prompt the driver to correct his or her posture such that the driver keeps a posture that enables the driver to immediately operate the pedal even during autonomous driving

Also, in the driver state recognition apparatus according to one or more aspects, if it is determined by the readiness determination unit that the driver is in the state of being able to immediately operate the pedal of the vehicle, the notification processing unit may perform processing for notifying the driver that a foot posture is appropriate.

According to the above driver state recognition apparatus, if it is determined that the driver is in a state of being able to immediately operate the pedal of the vehicle, processing for notifying the driver that the driver is adopting an appropriate foot posture is performed. In this manner, the driver can recognize that a foot posture during autonomous driving is appropriate.

Also, in the driver state recognition apparatus according to one or more aspects, if it is determined by the readiness determination unit that the driver is not in the state of being able to immediately operate the pedal of the vehicle, the notification processing unit may perform processing for notifying an autonomous driving control apparatus configured to control the autonomous driving system to continue rather than cancel autonomous driving.

According to the above driver state recognition apparatus, even if it is determined that the driver is not in the state of being able to immediately operate the pedal of the vehicle, it is possible to continue the autonomous driving control.

Also, the driver state recognition apparatus according to one or more aspects may include an information acquisition unit configured to acquire information arising during autonomous driving from the autonomous driving system, and the notification processing unit may perform predetermined notification processing, based on a determination result from the readiness determination unit and the information arising during autonomous driving that is acquired by the information acquisition unit.

According to the above driver state recognition apparatus, predetermined notification processing is performed according to the determination result from the readiness determination unit and the information arising during autonomous driving that is acquired by the information acquisition unit. In this manner, it is not required to needlessly perform various notifications to the driver and the like according to the situation of the autonomous driving system, thus enabling power and processing required for notification to be reduced.

Also, in the driver state recognition apparatus according to one or more aspects, the information arising during autonomous driving may include information for determining whether surroundings of the vehicle are in a safe state, and the notification processing unit may perform, if it is determined by the readiness determination unit that the driver is not in the state of being able to immediately operate the pedal of the vehicle, notification processing after changing a notification level for prompting the driver to correct the foot posture, according to whether the surroundings of the vehicle are in a safe state.

According to the above driver state recognition apparatus, if it is determined that the driver is not in the state of being able to immediately operate the pedal of the vehicle, it is possible to perform notification processing after changing the notification level for prompting the driver to correct his or her foot posture, according to whether the surroundings of the vehicle are in a safe state. As the information for determining whether the surroundings of the vehicle are in a safe state, it may be preferable that the information includes, for example, monitoring information of the surroundings of the vehicle. The monitoring information of surroundings of the vehicle may be, for example, information notifying that the vehicle is being rapidly approached by another vehicle, or may be information indicating that the vehicle will travel on a road where the functional limit of the system is envisioned, such as a narrow road with sharp curbs, and so on.

In a case where the surroundings of the vehicle are not in a safe state, for example, it may be preferable to raise the notification level and perform a high-level notification for more strongly alerting the driver, such as by combining display, audio, vibration, and so on, for example, so that the driver adopts a posture in which the driver can immediately take over the pedal operation. On the other hand, if the surroundings of the vehicle are in a safe state, it may be preferable to lower the notification level and perform a low-level notification by audio only, for example.

Also, in the driver state recognition apparatus according to one or more aspects, the information arising during autonomous driving may include takeover request information for taking over manual driving from autonomous driving, and the notification processing unit may perform, if it is determined by the readiness determination unit that the driver is not in the state of being able to immediately operate the pedal of the vehicle, and the information acquisition unit acquires the takeover request information, notification processing for prompting the driver to take over a driving operation.

According to the above driver state recognition apparatus, if it is determined that the driver is not in a state of being able to immediately operate the pedal of the vehicle, and the takeover request information is acquired, it is possible to perform notification processing for prompting the driver to take over the driving operation. The takeover request information may be information indicating that the vehicle has entered a takeover zone for taking over manual driving from autonomous driving, or information notifying that abnormality or a failure has occurred in a part of the autonomous driving system. If the takeover request information is acquired, actual pedal operation is required, and thus, for example, it may be preferable that notification is performed such that the driver takes over the driving operation by swiftly placing the foot on the pedal.

Also, the driver state recognition system according to one or more aspects may include any of the above driver state recognition apparatuses, and the load measurement unit configured to measure the load data acquired by the load data acquisition unit.

According to the above driver state recognition system, a system is constituted to include the driver state recognition apparatus and the load measurement unit. In this configuration, as described above, it is possible to construct a system that can accurately recognize whether the driver is adopting a posture that enables the driver to promptly take over the operation of pedal even during autonomous driving, and that is also able to appropriately provide support such that takeover of manual driving from autonomous driving can be performed promptly and smoothly, even in cases such as where a failure occurs in the autonomous driving system during autonomous driving.

Also, a driver state recognition method according to one or more aspects is a driver state recognition method for recognizing a driver state of a vehicle provided with an autonomous driving system, the method including:

a step of acquiring load data that is measured by a load measurement unit provided at a foot of a driver's seat of the vehicle;

a step of storing the acquired load data in a load data storage unit;

a step of reading out the load data from the load data storage unit;

a step of inferring a sitting posture of the driver using the read load data;

and a step of determining whether the driver is in a state of being able to immediately operate a pedal of the vehicle during autonomous driving based on inference information of the inferred sitting posture of the driver.

According to the above driver state recognition method, a sitting posture of the driver is inferred using the load data measured by the load measurement unit, and it is determined, based on the inference information of the sitting posture, whether the driver is in a state of being able to immediately operate the pedal of the vehicle during autonomous driving. In this configuration, it is possible to accurately recognize whether the driver is adopting a posture that enables the driver to promptly take over the pedal operation even during autonomous driving, and it is possible to provide support such that takeover of manual driving from autonomous driving, particularly takeover of the pedal operation, can be performed promptly and smoothly, even in cases such as where a failure occurs in the autonomous driving system during autonomous driving.

### BRIEF DESCRIPTION OF THE DRAWINGS

FIG. 1 is a block diagram illustrating a configuration of a relevant section of an autonomous driving system that includes a driver state recognition apparatus according to an embodiment 1.

FIGS. 2A and 2B are diagrams illustrating a vicinity of a driver's seat of a vehicle in which a driver state recognition system according to an embodiment 1 is installed, with FIG. 2A being a side view, and FIG. 2B being a plan view of a foot of a driver's seat.

FIG. 3 is a block diagram illustrating a hardware configuration of a driver state recognition apparatus according to an embodiment 1.

FIG. 4 is a diagram illustrating an example of definition data stored in a storage unit of a driver state recognition apparatus according to an embodiment 1.

FIG. 5 is a diagram illustrating an example of a readiness determination table stored in a storage unit of a driver state recognition apparatus according to an embodiment 1.

FIG. 6 is a flowchart illustrating a processing operation performed by a control unit in a driver state recognition apparatus according to an embodiment 1.

FIG. 7 is a block diagram illustrating an example of a hardware configuration of a driver state recognition apparatus according to an embodiment 2.

FIG. 8 is a flowchart illustrating a processing operation performed by a control unit in a driver state recognition apparatus according to an embodiment 2.

### DETAILED DESCRIPTION

Hereinafter, embodiments of a driver state recognition apparatus, a driver state recognition system, and a driver state recognition method will be described based on the drawings. Note that the following embodiments are specific examples of the present invention and various technical limitations are applied, but the scope of the present invention is not limited to these embodiments unless particularly stated in the following description.

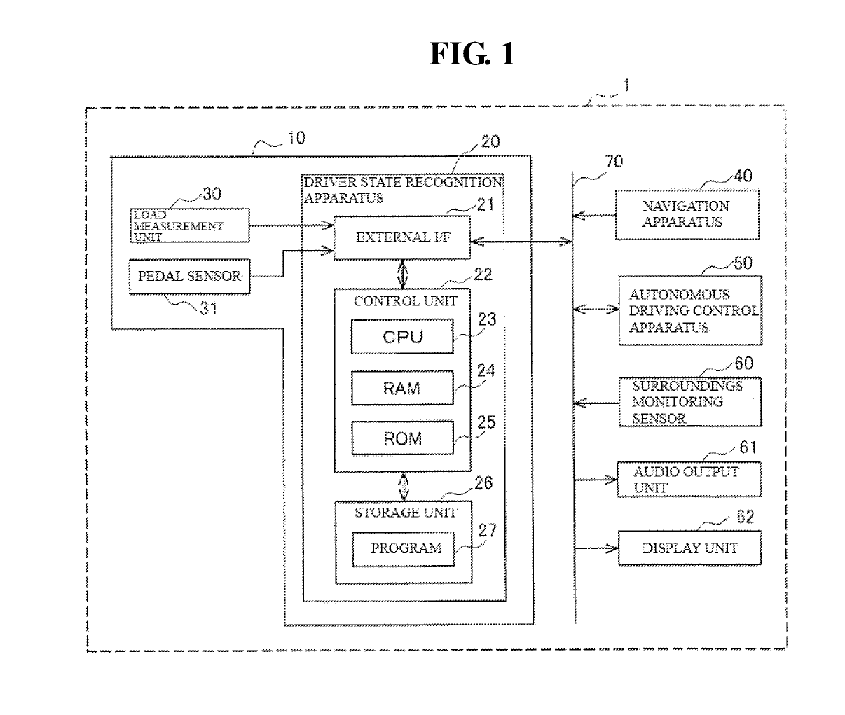

FIG. 1 is a block diagram showing a configuration of a relevant section of an autonomous driving system 1 that includes a driver state recognition apparatus 20 according to an embodiment 1.

The autonomous driving system 1 is configured to include a driver state recognition apparatus 20, a load measurement unit 30, a pedal sensor 31, a navigation apparatus 40, an autonomous driving control apparatus 50, a surroundings monitoring sensor 60, an audio output unit 61, and a display unit, and these units are connected via a bus line 70.

The autonomous driving system 1 includes an autonomous driving mode in which the system, as the agent, autonomously performs at least a part of travel control including acceleration, steering, and braking of a vehicle and a manual driving mode in which a driver performs the driving operation, and the system is constituted such that these modes can be switched.

The autonomous driving mode in an embodiment is envisioned as being a mode in which the autonomous driving system 1 autonomously performs all of acceleration, steering, and braking and the driver copes with requests when received from the autonomous driving system 1 (automation level equivalent to so-called level 3 or greater), but the application of an embodiment is not limited to this automation level. Also, times at which the autonomous driving system 1 requests takeover of manual driving during autonomous driving include, for example, at a time of the occurrence of a system abnormality or failure, at a time of the functional limit of the system, and at a time of the end of an autonomous driving interval.

The driver state recognition apparatus 20 is an apparatus for recognizing a state of a driver of a vehicle including the autonomous driving system 1, and is an apparatus for providing support, by recognizing the loading state of a foot of the driver on a floor at the foot of a driver's seat and the like and determining whether the driver is in a state of being able to immediately operate a pedal even during autonomous driving, so as to enable the driver to immediately perform takeover of manual driving, particularly takeover of the pedal operation, if there is a takeover request for manual driving from the autonomous driving system 1.

The driver state recognition apparatus 20 is configured to include an external interface (external I/F) 21, a control unit 22, and a storage unit 26. The control unit 22 is configured to include a Central Processing Unit (CPU) 23, a Random Access Memory (RAM) 24, and a Read Only Memory (ROM) 25.

The storage unit 26 is configured to include a storage apparatus that stores data with a semiconductor device, such as a flash memory, a hard disk drive, a solid-state drive, or other non-volatile memory or volatile memory. The storage unit 26 stores a program 27 to be executed by the driver state recognition apparatus 20 and the like. Note that part or all of the program 27 may be stored in the ROM 25 of the control unit 22.

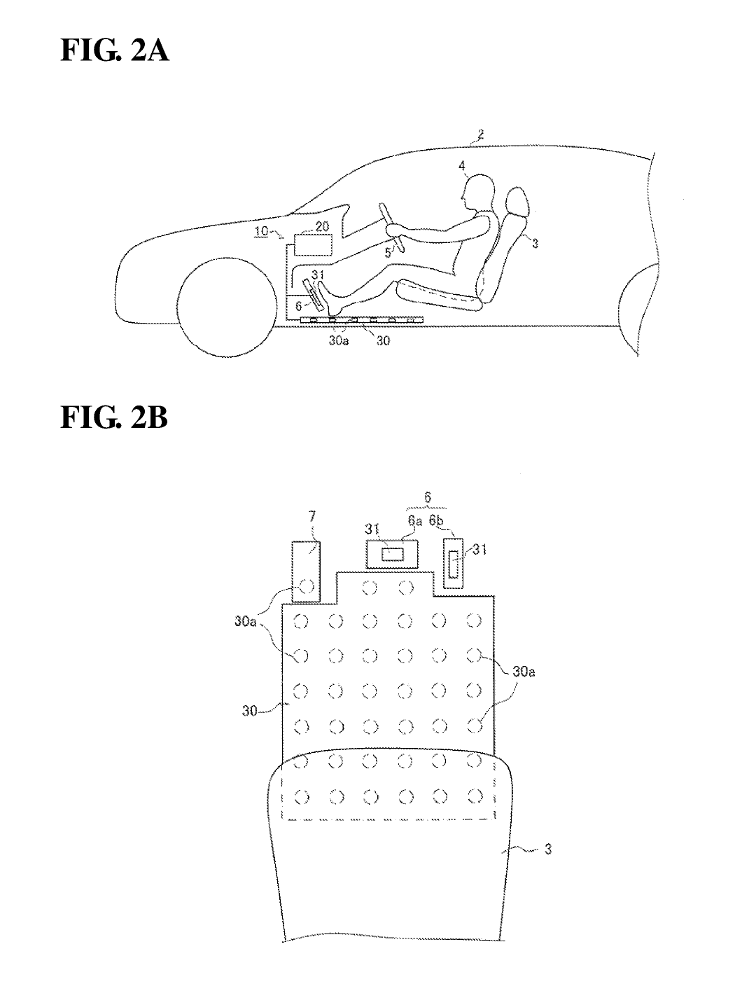

FIGS. 2A and 2B are diagrams showing a vicinity of the driver's seat of the vehicle in which a driver state recognition system 10 according to an embodiment 1 is installed, with FIG. 2A is a side view, and FIG. 2B being a plan view of the foot of the driver's seat.

The load measurement unit 30 is at least provided at a foot of a driver's seat 3 of a vehicle 2 and is configured to include sensors 30a for detecting a load position from the sole of the foot of the driver 4 and measuring a load value. The sensors 30a may be provided not only at the foot of the driver's seat 3 but also in a vicinity of a pedal 6 or a footrest 7.

For the sensors 30a, for example, a small load sensor (also referred to a weight sensor) configured to include a pressure sensitive device and the like may be used, but the present invention is not limited to this. The load measurement unit 30 may have a configuration in which the sensors 30a are arranged in a grid pattern in a floor mat, a mat that is different from the floor mat, or a floor sheet, which is provided at the foot of the driver's seat. The sensors 30a may also be provided on the footrest 7. Load data detected by the load measurement unit 30 is sent to the driver state recognition apparatus 20.

The pedal sensor 31 is a sensor for detecting a state in which a foot is placed on the pedal 6 (a brake pedal 6a and an accelerator pedal 6b) provided in the vehicle 2, and for the pedal sensor 31, a contact type sensor, a non-contact type sensor, or a displacement sensor may be used. Foot detection data detected by the pedal sensor 31 is sent to the driver state recognition apparatus 20. The driver state recognition system 10 is configured to include the driver state recognition apparatus 20, the load measurement unit 30, and the pedal sensor 31.

The navigation apparatus 40 shown in FIG. 1 is an apparatus for providing the driver with information such as a current position of the vehicle and a traveling route from the current position to a destination, and is configured to include a control unit, a display unit, an audio output unit, an operation unit, a map data storage unit, and the like (not shown). Also the navigation apparatus 40 is configured to be capable of acquiring a signal transmitted from a GPS receiver, a gyro sensor, a vehicle speed sensor, and the like (not shown).

The navigation apparatus 40 deduces information such as the road or traffic lane on which the vehicle is traveling and displays the current position on the display unit, based on the vehicle position information measured by the GPS receiver and the map information of the map data storage unit. In addition, the navigation apparatus 40 calculates a route from the current position of the vehicle to the destination and the like, displays the route information and the like on the display unit, and performs audio output of a route guide and the like from the audio output unit.

Also, some types of information such as vehicle position information, information of the road on which the vehicle is traveling, and scheduled traveling route information that are calculated by the navigation apparatus 40 are output to the autonomous driving control apparatus 50. The scheduled traveling route information may also include information related to switching control between autonomous driving and manual driving, such as information on start and end points of autonomous driving zones and information on zones for taking over manual driving from autonomous driving.

The autonomous driving control apparatus 50 is an apparatus for executing various kinds of control related to autonomous driving of the vehicle, and is configured by an electronic control unit including a control unit, a storage unit, an input/output unit and the like (not shown). The autonomous driving control apparatus 50 is also connected to a steering control apparatus, a power source control apparatus, a braking control apparatus, a steering sensor, an accelerator pedal sensor, a brake pedal sensor, and the like (not shown). These control apparatuses and sensors may be included in the configuration of the autonomous driving system 1.

The autonomous driving control apparatus 50 outputs a control signal for performing autonomous driving to each of the control apparatuses, performs autonomous traveling control of the vehicle (autonomous steering control, autonomous speed adjusting control, autonomous braking control and the like), and also performs switching control for switching between the autonomous driving mode and the manual driving mode, based on information acquired from each unit included in the autonomous driving system 1.

“Autonomous driving” refers to allowing the vehicle to autonomously travel along a road under control performed by the autonomous driving control apparatus 50 without the driver in the driver's seat performing the driving operation. For example, a driving state in which the vehicle is allowed to autonomously drive in accordance with a predetermined route to the destination or a traveling route that was automatically created based on circumstances outside of the vehicle and map information is included as autonomous driving. Then, if a predetermined cancellation condition of autonomous driving is satisfied, the autonomous driving control apparatus 50 may end (cancel) autonomous driving. For example, in the case where the autonomous driving control apparatus 50 determines that the vehicle that is driving autonomously has arrived at a predetermined end point of autonomous driving, the autonomous driving control apparatus 50 may perform control for ending autonomous driving. Also, if the driver performs an autonomous driving cancellation operation (for example, operation of an autonomous driving cancellation button, or operation of the steering wheel, acceleration, or braking or the like performed by the driver), the autonomous driving control apparatus 50 may perform control for ending autonomous driving. “Manual driving” refers to driving in which the driver drives the vehicle as the agent that performs the driving operation.

The surroundings monitoring sensor 60 is a sensor that detects target objects that exist in a vicinity of the vehicle. The target objects may include road markings (such as a white line), a safety fence, a highway median, and other structures that affect travelling of the vehicle and the like in addition to moving objects such as vehicles, bicycles, and people. The surroundings monitoring sensor 60 includes at least one of a forward-monitoring camera, a backward-monitoring camera, a radar, LIDER (that is, Light Detection and Ranging or Laser Imaging Detection and Ranging) and an ultrasonic sensor. Detection data of the target object detected by the surroundings monitoring sensor 60 is output to the autonomous driving control apparatus 50 and the like. As the forward-monitoring camera and the backward-monitoring camera, a stereo camera, a monocular camera or the like can be employed. The radar transmits radio waves such as millimeter waves to the surroundings of the vehicle, and detects positions, directions and distances of the target objects and the like by receiving radio waves reflected by the target objects that exist in the surroundings of the vehicle. LIDER involves transmitting laser light to the surroundings of the vehicle and detecting positions, directions and distances of the target objects and the like by receiving light reflected by the target objects that exist in the surroundings of the vehicle.

The audio output unit 61 is an apparatus that outputs various kinds of notifications based on instructions provided from the driver state recognition apparatus 20 with sound and voice, and is configured to include a speaker and the like.

The display unit 62 is an apparatus that displays various kinds of notifications and guidance based on instructions provided from the driver state recognition apparatus 20 with characters and graphics or by lighting and flashing a lamp or the like, and is configured to include various kinds of displays and indication lamps.

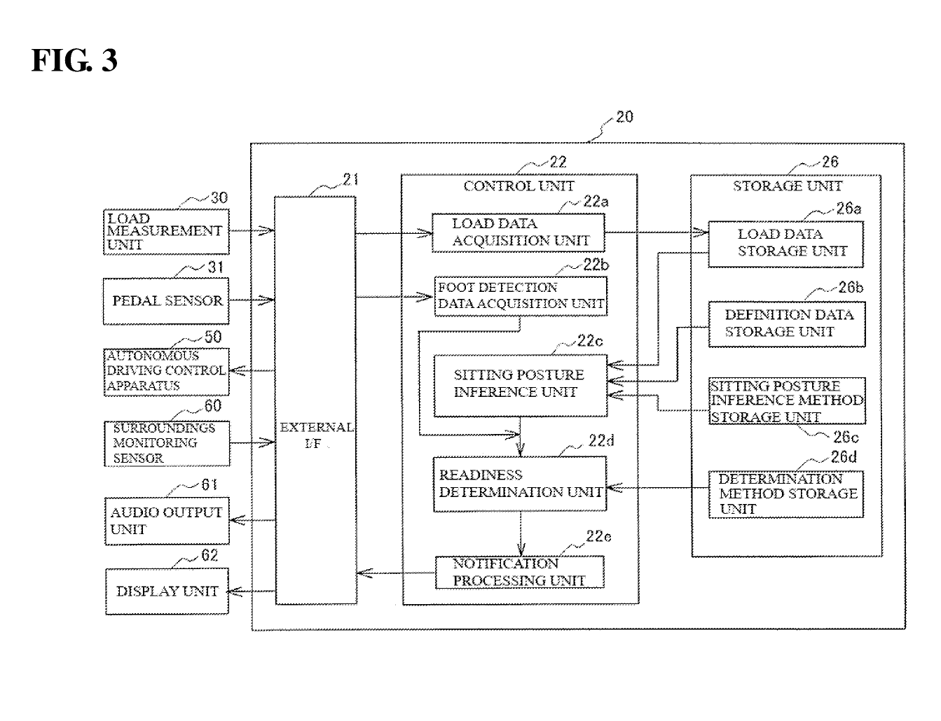

FIG. 3 is a block diagram showing an example of a hardware configuration of the driver state recognition apparatus 20 according to an embodiment 1.

The driver state recognition apparatus 20 is configured to include the external interface (external I/F) 21, the control unit 22, and the storage unit 26. The external I/F 21 is connected to, in addition to the load measurement unit 30 and the pedal sensor 31, each unit of the autonomous driving system 1 such as the autonomous driving control apparatus 50, the surroundings monitoring sensor 60, the audio output unit 61, the display unit 62, and is configured by an interface circuit and a connecting connector for transmitting and receiving a signal to and from each of these units.

The control unit 22 is configured to include a load data acquisition unit 22a, a foot detection data acquisition unit 22b, a sitting posture inference unit 22c, and a readiness determination unit 22d, and may be configured to further include a notification processing unit 22e.

The storage unit 26 is configured to include a load data storage unit 26a, a definition data storage unit 26b, a sitting posture inference method storage unit 26c, and a determination method storage unit 26d.

The load data storage unit 26a stores load data of the load measurement unit 30 that is acquired by the load data acquisition unit 22a.

The definition data storage unit 26b stores definition data used for inference processing of a sitting posture that is executed by the sitting posture inference unit 22c of the control unit 22. The definition data is data in which patterns of load data measured by the load measurement unit 30 and patterns of the sitting posture of the driver are associated with each other. The patterns of the load data may include at least multiple states in which positional relationships between each foot and the pedal differs.

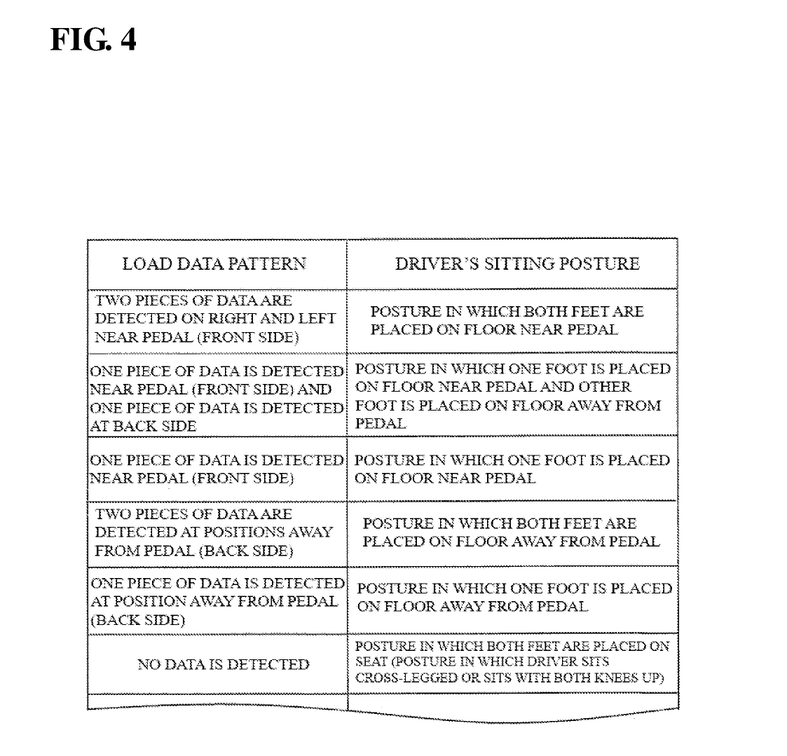

FIG. 4 shows an example of definition data stored in the definition data storage unit 26b. In the definition data shown in FIG. 4, the patterns of the load data and the patterns of the sitting posture of the driver are associated.

In the example shown in FIG. 4, the patterns of the load data include a pattern in which two pieces of the data are detected on the right and left near the pedal (a front side), a pattern in which one piece of the data is detected near the pedal (the front side) and one piece of the data is detected on a back side, a pattern in which one piece of the data is detected near the pedal (the front side), a pattern in which two pieces of the data are detected at positions away from the pedal (the back side), a pattern in which one piece of the data is detected at a position away from the pedal (the back side), and a pattern in which no data is detected.

Also, the patterns of the sitting posture of the driver that are associated with the above load data include a pattern of a posture in which both feet are placed on the floor near the pedal, a pattern of a posture in which one foot is placed on the floor near the pedal and the other foot is placed on the floor away from the pedal, a pattern of a posture in which one foot is placed on the floor near the pedal, a pattern of a posture in which both feet are placed on the floor away from the pedal, a pattern of a posture in which one foot is placed on the floor away from the pedal, and a pattern of a posture in which both feet are placed on the seat.

In this case, for the patterns of the load data, the patterns of the load detection position from each of the sensors 30a constituting the load measurement unit 30 are used, but load values of each of the sensors 30a may be used. Note that the patterns of the load data and the patterns of the sitting posture of the driver are not limited to the types shown in FIG. 4, patterns that are defined more specifically may be used according to the number of provided sensors 30a or detection data.

The sitting posture inference method storage unit 26c stores a program and the like to be executed by the sitting posture inference unit 22c of the control unit 22.

The determination method storage unit 26d stores data such as a readiness determination table and a program that is executed by the readiness determination unit 22d of the control unit 22 and used for determining whether the driver is in a state of being able to immediately operate the pedal, that is, for determining the readiness for the pedal operation. For the readiness determination table, a table that shows the relationship between various sitting postures (states of the feet) of the driver and the readiness for the pedal operation may be used, for example.

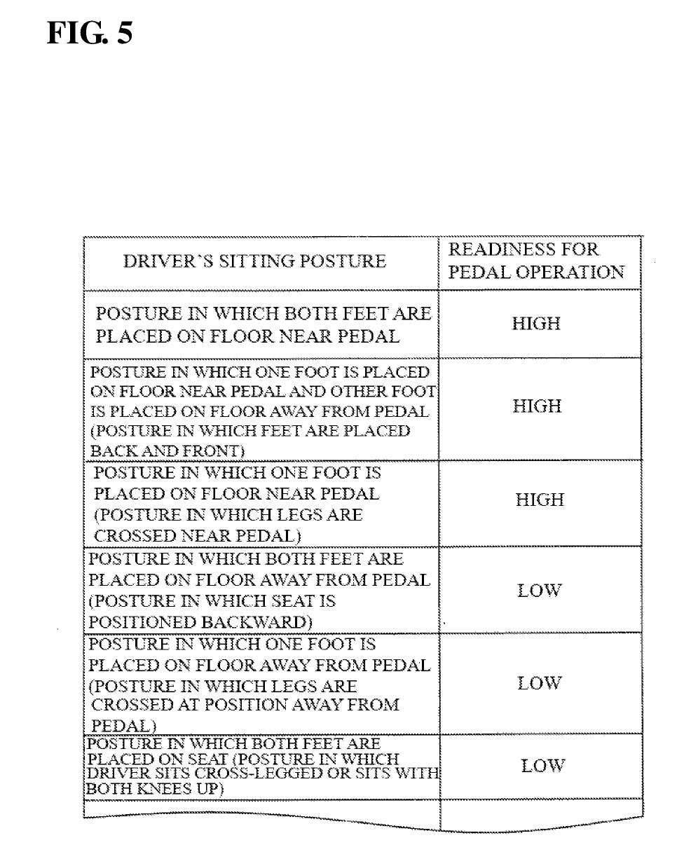

FIG. 5 shows an example of the readiness determination table stored in the determination method storage unit 26d. The readiness determination table stores the relationship between sitting postures of the driver and the readiness for the pedal operation. The readiness for the pedal operation refers to the rapidity with which the driver can operate the pedal 6 if the autonomous driving system 1 stops operating for some reason and autonomous driving cannot be continued.

Accordingly, the state of high readiness for the pedal operation means the state in which the driver can operate the pedal as soon as the driver needs to operate the pedal, and thus it is not necessary for a foot to be placed on the pedal. The readiness for the pedal operation may be set in advance based on the positional relationships between each of the legs and the pedal, for example, if one foot is placed on the floor near the pedal, it may be determined that the readiness for the pedal operation is high.

In the examples shown in FIG. 5, the readiness of the pedal operation is defined as high with respect to a posture in which both feet are placed on the floor near the pedal, a posture in which one foot is placed on the floor near the pedal and the other foot is placed on the floor away from the pedal (a posture in which the feet are placed back and front), and a posture in which one foot is placed on the floor near the pedal (a posture in which the legs are crossed near the pedal). On the other hand, the readiness for the pedal operation is defined as low with respect to a posture in which both feet are placed on the floor away from the pedal (a posture in which the seat is positioned backward), a posture in which one foot is placed on the floor away from the pedal (a posture in which the legs are crossed at a position away from the pedal), and a posture in which both feet are placed on the seat (a posture in which the driver sits cross-legged or sits with both knees up).

It is possible to determine the readiness for the pedal operation corresponding to the sitting posture inferred by the sitting posture inference unit 22c using this readiness determination table.

The control unit 22 is an apparatus that realizes functions of the load data acquisition unit 22a, the foot detection data acquisition unit 22b, the sitting posture inference unit 22c, the readiness determination unit 22d, the notification processing unit 22e and the like, by performing, in cooperation with the storage unit 26, processing for storing various data in the storage unit 26, and by reading out various kinds of data and programs stored in the storage unit 26 and causing the CPU 23 to execute these programs.

The load data acquisition unit 22a constituting the control unit 22 performs processing for acquiring the load data measured by the load measurement unit 30 and performs processing for storing the acquired load data in the load data storage unit 26a. The load data includes data that shows the load position or the load value from the sensors 30a. The acquiring processing of the load data may be started, for example, after the driver state recognition apparatus 20 has been activated. Alternatively, the load data may be acquired after the driving mode is switched to the autonomous driving mode.

The foot detection data acquisition unit 22b performs processing for acquiring the foot detection data from the pedal sensor 31. The acquired foot detection data is used for determination processing performed by the readiness determination unit 22d.

The sitting posture inference unit 22c reads out the load data stored in the load data storage unit 26a, and performs processing for inferring a sitting posture of the driver based on the definition data read out from the definition data storage unit 26b and the program read out from the sitting posture inference method storage unit 26c. More specifically, the sitting posture inference unit 22c determines the pattern of the various load data defined in the definition data to which the load data is similar, extracts the sitting posture that is associated with the determined load data pattern, and infers a sitting posture of the driver.

Also, the sitting posture inference unit 22c infers a distance between the foot and the pedal using the load data, if the distance is in a predetermined range, the sitting posture inference unit 22c may determine that the foot is placed near the pedal 6, that is, that the readiness is high.

The readiness determination unit 22d performs processing for determining whether the driver is in a state of being able to immediately operate the pedal, based on the program and the readiness determination table read out from the determination method storage unit 26d and the sitting posture of the driver that is inferred by the sitting posture inference unit 22c.

If the readiness determination unit 22c determines that the driver is not in a state of being able to immediately operate the pedal (the state in which the readiness is low), the notification processing unit 22e performs notification processing for causing the audio output unit 61 and the display unit 62 to perform audio output and display output for prompting the driver to adopt a posture that enables the driver to immediately operate the pedal. The notification processing may be performed according to the sitting posture. Also, the notification processing unit 22e may output a signal notifying to continue autonomous driving rather than cancel autonomous driving to the autonomous driving control apparatus 50.

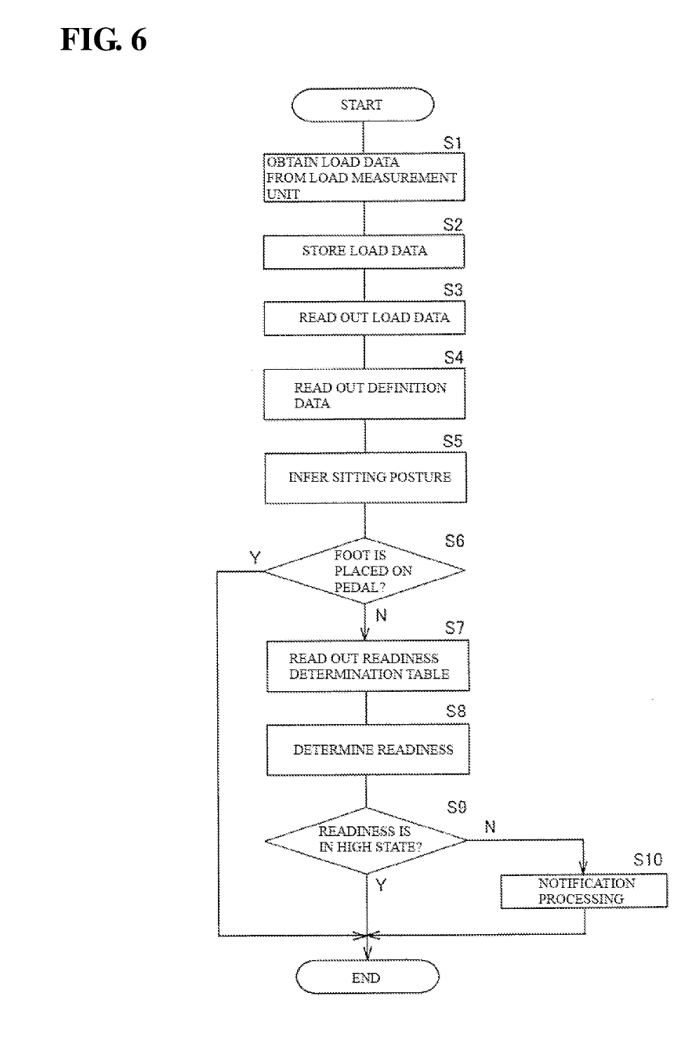

FIG. 6 is a flowchart showing a processing operation performed by the control unit 22 in the driver state recognition apparatus 20 according to an embodiment 1. Here, description will be given, assuming that the autonomous driving system 1 is set to the autonomous driving mode, that is, the vehicle is in a state of traveling under the autonomous driving control. This processing operation is repeatedly performed during the period in which the autonomous driving mode is set.

First, in step S1, processing for acquiring the load data of the driver detected by the sensors 30a of the load measurement unit 30 is performed. The load data may be acquired at a certain time period. In the following step S2, processing for storing the acquired load data in the load data storage unit 26a is performed, and thereafter the processing moves to step S3.

In step S3, the load data stored in the load data storage unit 26a is read out, and then the processing moves to step S4. The load data may be collectively read out over a certain time period from the load data storage unit 26a. In the following step S4, the definition data is read out from the definition data storage unit 26b, the program and the like for inferring a sitting posture of the driver are read out from the sitting posture inference method storage unit 26c, and thereafter the processing moves to step S5.

In step S5, based on the load data read out in step S3 and the definition data read out in step S4, the processing for inferring a sitting posture of the driver is performed. More specifically, a pattern corresponding to the load data (similarity thereof is high) that was read out in step S3 is distinguished among the multiple patterns of load data defined in the definition data shown in FIG. 4, and then a sitting posture that is associated with the distinguished load data is inferred as the sitting posture of the driver.

In the following step S6, it is determined whether the foot detection data is acquired from the pedal sensor 31, that is, it is determined whether a foot is placed on the pedal, and if it is determined that the foot detection data is acquired, thereafter the processing ends because the readiness for operating the pedal is high.

On the other hand, in step S6, if it is determined that the foot detection data is not acquired from the pedal sensor 31, the processing moves to step S7. In step S7, the readiness determination table as shown in FIG. 5 is read out from the determination method storage unit 26d, and thereafter the processing moves to step S8.

In step S8, the readiness that is associated with the sitting posture of the driver that is inferred in step S5 is determined from the readiness determination table. For example, if the sitting posture of the driver inferred in step S5 is a posture in which both feet are placed on the floor near the pedal, it is determined that the readiness is high. Also, if the sitting posture of the driver inferred in step S5 is a posture in which both feet are placed on the seat, it is determined that the readiness is low.

In the following step S9, it is determined whether the readiness is in a high state, and if it is determined that the readiness is in the high state, that is, if it is determined that the driver is in a state of being able to immediately operate the pedal, thereafter the processing ends. Note that, in step S9, if the determination result showing that the readiness is high in step S8 has been detected for a certain time period, it may be determined that the readiness is in the high state. Also, in another embodiment, notification processing for notifying the driver that the driver is adopting an appropriate foot posture may be performed, such as, for example, by providing an appropriate posture notification lamp in the display unit 62 and turning on an appropriate posture notification lamp. Alternatively, a signal notifying the driver that the driver is adopting an appropriate foot posture, that is, that the driver is adopting an appropriate posture for continuing autonomous driving, may be output to the autonomous driving control apparatus 50.

On the other hand, in step S9, if it is determined that the readiness of the pedal operation is not in the high state, that is, if it is determined that the readiness is in a low state, thereafter the processing moves to step S10. Note that, in step S9, if the determination result showing that the readiness is low in step S8 has been detected for a certain time period, it may be determined that the readiness is in the low state.

In step S10, notification processing for prompting the driver to adopt an appropriate foot posture is performed. As notification processing, processing for outputting predetermined audio from the audio output unit 61 may be performed, or processing for displaying predetermined display on the display unit 62 may be performed. Also, notification according to the state of the feet may be performed. For example, if the feet of the driver are placed on the seat, audio such as “please lower both feet to near the pedal” may be output. Also, in step S10, a signal for continuing autonomous driving rather than canceling autonomous driving may be output to the notifying autonomous driving control apparatus 50.

In the above driver state recognition system 10 according to an embodiment 1, a system is constituted by the driver state recognition apparatus 20, the load measurement unit 30 provided at the foot of the driver's seat of the vehicle, and the pedal sensor 31. Also, according to the driver state recognition apparatus 20, the sitting posture inference unit 22c infers a sitting posture of the driver, based on the load data measured by the sensors 30a of the load measurement unit 30 and the definition data stored in the definition data storage unit 26b. Then, it is determined, by the readiness determination unit 22d, whether the driver is in a state of being able to immediately operate the brake pedal or the accelerator pedal of the vehicle during autonomous driving, based on the inference information of the sitting posture of the driver.

In this manner, it is possible to accurately recognize whether the driver is adopting a sitting posture that enables the driver to immediately take over the pedal operation even during autonomous driving, and it is possible to appropriately provide support such that takeover of manual driving from autonomous driving, particularly takeover of the pedal operation, is promptly and smoothly performed, even in cases such as where a failure occurs in the autonomous driving system 1 during autonomous driving.

Also, according to the driver state recognition apparatus 20, if the foot detection data acquisition unit 22b acquires the foot detection data from the pedal sensor 31, it can be determined that the driver is in a state of being able to operate the pedal of the vehicle during autonomous driving, regardless of the sitting posture of the driver.

Also, according to the driver state recognition apparatus 20, if it is determined by the readiness determination unit 22d that the driver is not in a state of being able to immediately operate the pedal of the vehicle, that is, if it is determined that the readiness for the pedal operation is low, the notification processing for prompting the driver to adopt an appropriate foot posture is performed by the notification processing unit 22e. In this manner, it is possible to prompt the driver to correct his or her posture so as to keep a posture that enables the driver to immediately operate the pedal even during autonomous driving.

Note that, the above driver state recognition system 10 according to an embodiment 1 is configured to include the pedal sensor 31, but, in another embodiment, a driver state recognition system may be configured by the driver state recognition apparatus 20 and the load measurement unit 30.

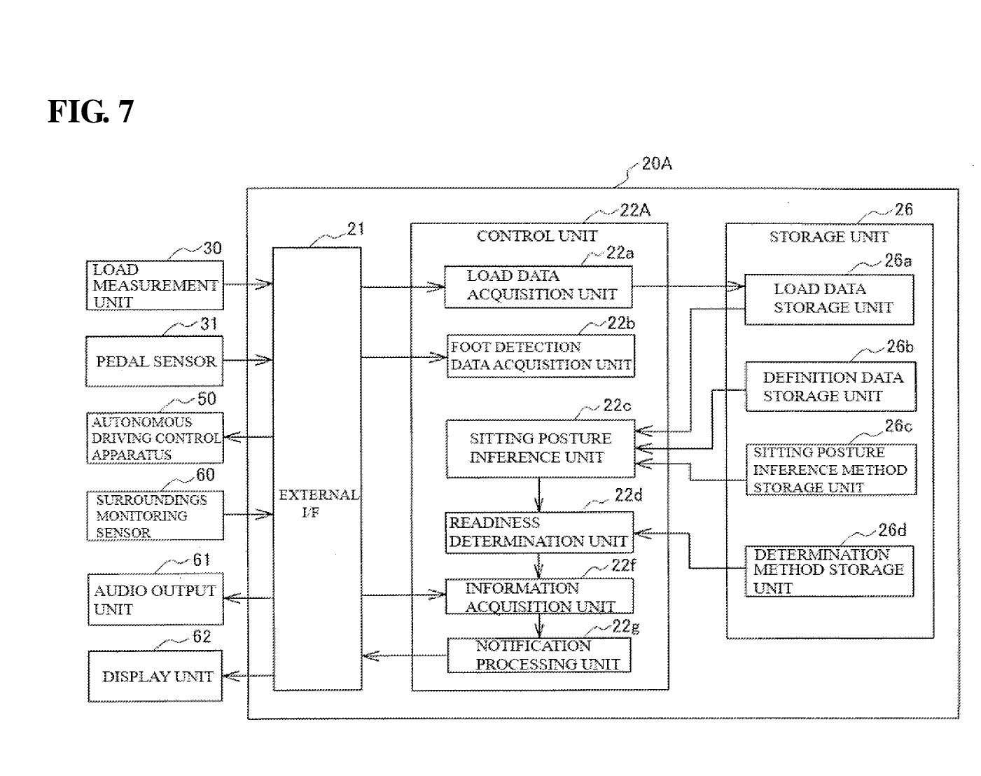

FIG. 7 is a block diagram showing an example of a hardware configuration of a driver state recognition apparatus 20A according to an embodiment 2. Note that constituent components that have the same functions as those of the driver state recognition apparatus 20 shown in FIG. 3 are assigned the same numerals, and description thereof is omitted here.

The configuration of the driver state recognition apparatus 20A according to an embodiment 2 differs from the driver state recognition apparatus 20 according to an embodiment 1 in processing that is executed by a notification processing unit 22g of a control unit 22A.

The control unit 22A is configured to include the load data acquisition unit 22a, the foot detection data acquisition unit 22b, the sitting posture inference unit 22c, and the readiness determination unit 22d, and may be configured to further include an information acquisition unit 22f and the notification processing unit 22g.

The information acquisition unit 22f acquires information arising during the autonomous driving from the units of the autonomous driving system 1. The information arising during the autonomous driving includes at least one of monitoring information of surroundings of the vehicle that is detected by the surroundings monitoring sensor 60 and takeover request information for taking over manual driving from autonomous driving that is sent from the autonomous driving control apparatus 50.

If the readiness determination unit 22d determines that the driver is not in a state of being able to immediately operate the pedal (the state in which the readiness is low), the notification processing unit 22g performs, according to the information arising during autonomous driving that is acquired by the information acquisition unit 22f, processing for causing the audio output unit 61 and the display unit 62 to perform outputting processing of audio and display for prompting the driver to adopt a posture that enables the driver to immediately operate the pedal. Also, the notification processing unit 22g may output a signal notifying to continue autonomous driving rather than cancel autonomous driving to the autonomous driving control apparatus 50.

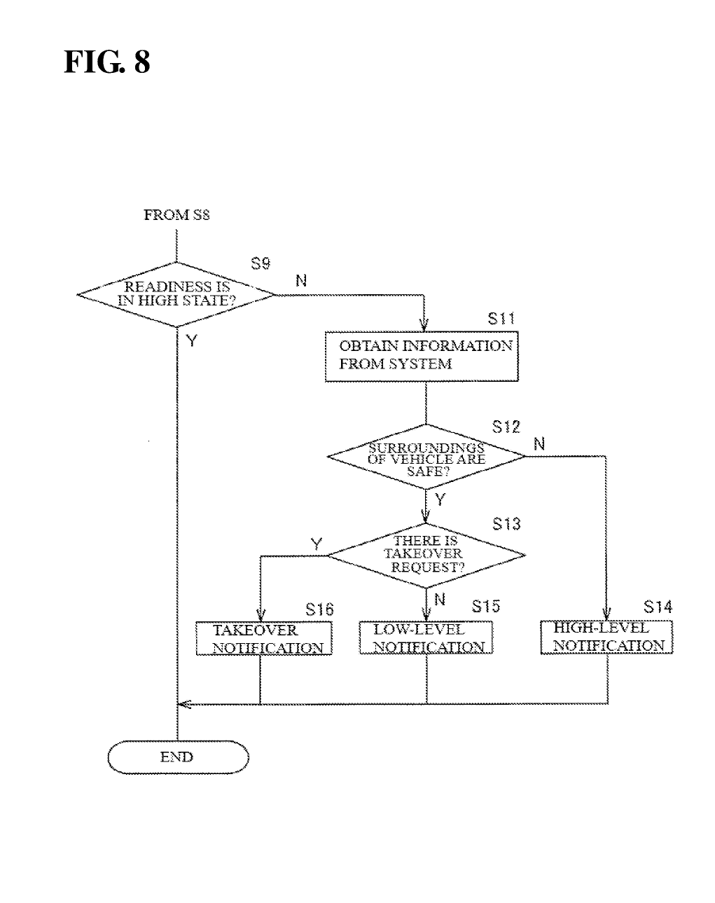

FIG. 8 is a flowchart showing a processing operation performed by the control unit 22A in the driver state recognition apparatus 20A according to an embodiment 2. Note that the processing from steps S1 to S9 are similar to the processing shown in FIG. 6, and description thereof is omitted here.

On the other hand, in step S9, if it is determined that the readiness is not in the high state, that is, if it is determined that the readiness is in the low state, and thereafter the processing moves to step S11. Information is acquired from the autonomous driving system 1 in step S11, and then the processing moves to step S12. The information includes the monitoring information of surroundings of the vehicle that was detected by the surroundings monitoring sensor 60 and the takeover request information for taking over manual driving that is output from the autonomous driving control apparatus 50. The takeover request information includes, for example, a system abnormality (failure) occurrence signal, a system functional limit signal, or an entry signal indicating entry to a takeover zone.

In step S12, it is determined whether the surroundings of the vehicle are in a safe state, based on the monitoring information of surroundings of the vehicle that was acquired from the surroundings monitoring sensor 60. In step S12, if it is determined that the surroundings of the vehicle are not in a safe state, such as, for example, if it is determined that information indicating that another vehicle, a person, or other obstacle is detected in a certain range of the surroundings of the vehicle (any of forward, lateral, and backward), information notifying that another vehicle is rapidly approaching, or information indicating that the vehicle will travel on a road where the functional limit of the system is envisioned, such as a narrow road with sharp curbs, was acquired, and then the processing moves to the high-level notification processing in step S14. In step S14, the high-level notification processing is performed with audio and display for causing the driver to promptly adopt a posture that enables the driver to immediately operate the pedal, and then the processing ends. In the high-level notification processing, it is preferable that notification is performed in which display and audio are combined. Notification other than display or audio, such as, for example, applying vibrations to the driver's seat or the like may be added. Also, in step S14, a signal for continuing autonomous driving rather than canceling autonomous driving may be output to the notifying autonomous driving control apparatus 50.

On the other hand, in step S12, if it is determined that the surroundings of the vehicle are in a safe state, and thereafter the processing moves to step S13. In step S13, it is determined whether takeover request information for taking over manual driving has been acquired from the autonomous driving control apparatus 50, that is, it is determined whether there is a takeover request. In step S13, if it is determined that there is no takeover request, the processing moves to the low-level notification processing of step S15. In step S15, the low-level notification processing is performed for causing the driver to adopt a posture that enables the driver to operate the pedal, and then the processing ends. In the low-level notification processing, it is preferable to gently notify the driver, such as notification through display only, in order to achieve harmony between the autonomous driving and the driver.

On the other hand, in step S13, if it is determined that there is the takeover request, the processing moves to step S16. In step S16, takeover notification is performed by audio or display such that the driver immediately holds the steering wheel and takes over the driving, and then the processing ends.

In the above driver state recognition apparatus 20A according to an embodiment 2, the notification processing unit 22g performs notification processing according to information arising during autonomous driving that is acquired by the information acquisition unit 22f. If surroundings monitoring information indicating that the vehicle-surroundings are not in a safe state is acquired, it is possible to raise the level of the notification performed by the notification processing unit 22g to more strongly alert the driver, such that the driver adopts a posture that enables the driver to immediately take over the pedal operation. Also, if the surroundings of the vehicle are safe, and there is no takeover request, it is possible to gently prompt the driver to correct his or her posture through the notification. On the other hand, if there is the takeover request information, it is possible to notify the driver so as to adopt a posture for immediately taking over manual driving.

In this manner, it is not required to needlessly perform various notifications to the driver according to the state of the autonomous driving system 1, and thus power and processing required for the notification can be reduced. Also, at the time of failure occurrence or an operating limit of the system, or at the time of a request for taking over the manual driving, the time period until the driver operates the pedal and the takeover of the driving operation is completed can be shortened, thus enabling an appropriate notification that is gentle on the driver to be performed, according to the state of the autonomous driving system 1.

Note that, the information acquisition unit 22f may be provided in the driver state recognition apparatus 20 according to the above embodiment 1, and instead of step S10 shown in FIG. 6, similar processing of steps S11 to S16 shown in FIG. 8 may be performed, that is, notification processing may be performed according to information arising during autonomous driving that is acquired by the information acquisition unit 22f.

1. A driver state recognition apparatus for recognizing a state of a driver of a vehicle provided with an autonomous driving system, comprising:
a load data acquisition unit configured to acquire load data that is measured by a load measurement unit provided at a foot of a driver's seat of the vehicle;
a sitting posture inference unit configured to infer a sitting posture of the driver using the load data acquired by the load data acquisition unit; and
a readiness determination unit configured to determine whether the driver is in a state of being able to immediately operate a pedal of the vehicle during autonomous driving, based on inference information from the sitting posture inference unit.

2. The driver state recognition apparatus according to claim 1,
wherein, if it is inferred by the sitting posture inference unit that the driver is adopting a sitting posture in which at least one foot is placed on a floor near the pedal of the vehicle, the readiness determination unit determines that readiness is in a high state.

3. The driver state recognition apparatus according to claim 1, further comprising:
a definition data storage unit configured to store definition data in which a pattern of the load data measured by the load measurement unit and a pattern of the sitting posture of the driver are associated with each other,
wherein the sitting posture inference unit infers the sitting posture of the driver, based on the load data acquired by the load data acquisition unit and the definition data read out from the definition data storage unit.

4. The driver state recognition apparatus according to claim 1, further comprising:
a foot detection data acquisition unit configured to acquire foot detection data of a pedal sensor configured to detect a state in which the foot of the driver is placed on the pedal of the vehicle,
wherein, if the foot detection data acquisition unit acquires the foot detection data, the readiness determination unit determines that the driver is in the state of being able to immediately operate the pedal of the vehicle during autonomous driving.

5. The driver state recognition apparatus according to claim 1, further comprising:
a notification processing unit configured to perform predetermined notification processing based on a determination result of the readiness determination unit.

6. The driver state recognition apparatus according to claim 5,
wherein, if it is determined by the readiness determination unit that the driver is not in the state of being able to immediately operate the pedal of the vehicle, the notification processing unit performs notification processing for prompting the driver to adopt an appropriate foot posture.

7. The driver state recognition apparatus according to claim 5,
wherein, if it is determined by the readiness determination unit that the driver is in the state of being able to immediately operate the pedal of the vehicle, the notification processing unit performs processing for notifying the driver that a foot posture is appropriate.

8. The driver state recognition apparatus according to claim 5,
wherein, if it is determined by the readiness determination unit that the driver is not in the state of being able to immediately operate the pedal of the vehicle, the notification processing unit performs processing for notifying an autonomous driving control apparatus configured to control the autonomous driving system to continue rather than cancel autonomous driving.

9. The driver state recognition apparatus according to claim 5, further comprising:
an information acquisition unit configured to acquire information arising during autonomous driving from the autonomous driving system,
wherein the notification processing unit performs predetermined notification processing, based on a determination result from the readiness determination unit and the information arising during autonomous driving that is acquired by the information acquisition unit.

10. The driver state recognition apparatus according to claim 9,
wherein the information arising during autonomous driving includes information for determining whether surroundings of the vehicle are in a safe state, and
the notification processing unit performs, if it is determined by the readiness determination unit that the driver is not in the state of being able to immediately operate the pedal of the vehicle, notification processing after changing a notification level for prompting the driver to correct the foot posture, according to whether the surroundings of the vehicle are in a safe state.

11. The driver state recognition apparatus according to claim 9,
wherein the information arising during autonomous driving includes takeover request information for taking over manual driving from autonomous driving, and
the notification processing unit performs, if it is determined by the readiness determination unit that the driver is not in the state of being able to immediately operate the pedal of the vehicle, and the information acquisition unit acquires the takeover request information, notification processing for prompting the driver to take over a driving operation.

12. A driver state recognition system comprising:
the driver state recognition apparatus according to claim 1; and
the load measurement unit configured to measure the load data acquired by the load data acquisition unit.

13. The driver state recognition apparatus according to claim 2, further comprising:
a definition data storage unit configured to store definition data in which a pattern of the load data measured by the load measurement unit and a pattern of the sitting posture of the driver are associated with each other,
wherein the sitting posture inference unit infers the sitting posture of the driver, based on the load data acquired by the load data acquisition unit and the definition data read out from the definition data storage unit.

14. The driver state recognition apparatus according to claim 2, further comprising:
a foot detection data acquisition unit configured to acquire foot detection data of a pedal sensor configured to detect a state in which the foot of the driver is placed on the pedal of the vehicle,
wherein, if the foot detection data acquisition unit acquires the foot detection data, the readiness determination unit determines that the driver is in the state of being able to immediately operate the pedal of the vehicle during autonomous driving.

15. The driver state recognition apparatus according to claim 2, further comprising:
a notification processing unit configured to perform predetermined notification processing based on a determination result of the readiness determination unit.

16. The driver state recognition apparatus according to claim 3, further comprising:
a foot detection data acquisition unit configured to acquire foot detection data of a pedal sensor configured to detect a state in which the foot of the driver is placed on the pedal of the vehicle,
wherein, if the foot detection data acquisition unit acquires the foot detection data, the readiness determination unit determines that the driver is in the state of being able to immediately operate the pedal of the vehicle during autonomous driving.

17. The driver state recognition apparatus according to claim 3, further comprising:
a notification processing unit configured to perform predetermined notification processing based on a determination result of the readiness determination unit.

18. A driver state recognition method for recognizing a state of a driver of a vehicle provided with an autonomous driving system, comprising:
acquiring load data that is measured by a load measurement unit provided at a foot of a driver's seat of the vehicle;
storing the acquired load data in a load data storage unit;
reading out the load data from the load data storage unit;
inferring a sitting posture of the driver using the read load data; and
determining whether the driver is in a state of being able to immediately operate a pedal of the vehicle during autonomous driving, based on inference information of the inferred sitting posture of the driver.
